(19) United States
(12) Patent Application Publication
(10) Pub. No.: US 2026/0145972 A1
(43) Pub. Date: May 28, 2026

(54) DURABLE LEEFT-METAL CONFIGURATION FOR WATER DISINFECTION

(71) Applicant: Georgia Tech Research Corporation, Atlanta, GA (US)

(72) Inventors: Xing Xie, Atlanta, GA (US); Wei Wang, Atlanta, GA (US); Mourin Jarin, Atlanta, GA (US); Ting Wang, Atlanta, GA (US)

(21) Appl. No.: 19/398,537

(22) Filed: Nov. 24, 2025

Related U.S. Application Data
(60) Provisional application No. 63/723,617, filed on Nov. 22, 2024.

(51) Int. Cl. C02F 1/467

(52) U.S. Cl. CPC C02F 1/467; C02F 2201/4611; C02F 2201/46135; C02F 2201/4615; C02F 2209/40; C02F 2303/04

(57) ABSTRACT

The present disclosure provides a system for disinfecting fluid comprising a cylindrical outer electrode defining an internal cavity and a center electrode positioned within the cavity. The center electrode extends along the longitudinal axis and comprises an inner wire and outer shell surrounding the wire. An inlet at the first end allows fluid to enter the cavity. An outlet at the second end allows fluid to exit. A voltage source applies voltage across the electrodes. The outer electrode comprises copper and inner wire comprises stainless steel. The outer shell comprises copper electrodeposited from the outer electrode. First voltage polarity results in electrodeposition from outer electrode to outer shell, while opposite polarity results in ionization of the outer shell metal for disinfection.

### CROSS-REFERENCE TO RELATED APPLICATIONS

This application claims the benefit of U.S. Provisional Application Serial No. 63/723,617, filed on 22 Nov. 2024, which is incorporated herein by reference in its entirety as if fully set forth below.

### GOVERNMENT LICENSE RIGHTS

This invention was made with government support under 2025462 and 2329669 awarded by the National Science Foundation. The government has certain rights in this invention.

### FIELD OF INVENTION

The present disclosure relates to water disinfection systems, and more particularly to a durable locally enhanced electric field treatment (LEEFT) system with a stainless steel/metal core-shell electrode configuration for long-term water disinfection applications.

### BACKGROUND

Drinking water safety represents a fundamental global concern for public health protection. Approximately 4.4 billion people in low- and middle-income countries lack access to safely managed drinking water services. One of the primary challenges in providing safe drinking water involves pathogenic microbial contamination, which can lead to waterborne disease outbreaks. Effective disinfection processes that can inactivate pathogens are therefore fundamental to ensuring drinking water safety.

Current standard drinking water disinfection techniques include chlorine-based disinfectants, UV irradiation, and ozonation. While these methods are widely employed and generally effective, each approach has inherent limitations. Chlorination has the potential to generate harmful disinfection byproducts (DBPs), which may pose risks to human health. UV irradiation and ozonation do not provide residual disinfection, making treated water vulnerable to microbial regrowth or biofilm formation within distribution systems. Alternative techniques that provide high inactivation performance while minimizing DBPs formation and enabling residual disinfection would be advantageous.

Copper is a natural element with inherent antimicrobial properties. When copper ions interact with microorganisms, they can disrupt cell membrane integrity, bind to intracellular components, and change intracellular reactive oxygen species, ultimately inducing cell death without generating DBPs. Copper has been employed as an antimicrobial surface and applied in home water storage containers for microbial control. In its ionic form, copper typically requires concentrations above 3 mg/L for effective microbial inactivation, which exceeds the maximum contaminant level goal of 1.3 mg/L for drinking water set by the United States Environmental Protection Agency.

To enhance disinfection at lower copper concentrations, copper has been combined with other metals or techniques. For example, copper-silver ionization combines the antimicrobial properties of both copper and silver ions and has been applied in various settings such as swimming pools and hospital water systems. However, the higher cost of silver and its greater toxicity compared with copper has limited direct application for drinking water disinfection.

Copper has been combined with electric field treatment for microbial inactivation. Electric field treatment increases the permeability of lipid bilayer membranes, inducing cell damage or death. Conventional electric field treatment applies voltages up to tens of kilovolts to realize strong electric fields. This high voltage requirement can be reduced in locally enhanced electric field treatment (LEEFT) devices through specific electrode and system design. The increased membrane permeability allows copper ions to act more rapidly in causing irreversible cell damage and cell death.

Tubular copper ionization cells with coaxial electrodes that combine LEEFT with copper have been developed for water disinfection. These systems achieve high disinfection performance without producing DBPs and provide residual disinfection. In such designs, a cylinder outer electrode serves as the cathode and a thin center copper wire acts as the anode. When voltage is applied, a locally enhanced electric field forms near the center electrode while copper ions are released from the center electrode, generating a concentration gradient with higher copper concentrations near the center electrode. However, continuous consumption of the center electrode requires periodic system shutdown and disassembly for electrode replacement. Furthermore, pitting corrosion of the electrode results in low copper utilization efficiency, limiting the practical application of such systems for long-term operation.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for disinfecting a fluid is provided. The system comprises a cylindrically-shaped outer electrode defining an internal cavity. The system comprises a center electrode positioned within the internal cavity, the center electrode extending along at least a portion of a longitudinal axis of the outer electrode, the center electrode comprising an inner wire and an outer shell surrounding the inner wire. The system comprises an inlet positioned proximate a first end of the outer electrode and configured to allow a fluid to pass from an area external to the cavity into the cavity. The system comprises an outlet positioned proximate a second end of the outer electrode and configured to allow the fluid to pass from the cavity into an area external to the cavity. The system comprises a voltage source configured to apply a voltage across the outer electrode and the center electrode.

According to other aspects of the present disclosure, the system may include one or more of the following features. The outer electrode may comprise copper. The inner wire may comprise stainless steel. The outer shell may comprise copper. Application of a first voltage having a first polarity may result in electrodeposition of a metal from the outer electrode to the outer shell. Application of a second voltage having a second polarity opposite the first polarity may result in ionization of the metal of the outer shell. The metal may comprise copper and the ionization may produce copper ions at a concentration between 400 and 520 micrograms per liter in the fluid.

According to another aspect of the present disclosure, a water disinfection device is provided. The water disinfection device comprises a tubular outer electrode comprising copper and defining an internal flow channel. The water disinfection device comprises a core-shell center electrode positioned within the internal flow channel and extending along a longitudinal axis of the tubular outer electrode, the core-shell center electrode comprising a wire core and a shell electrodeposited onto the stainless steel wire core. The water disinfection device comprises a fluid inlet configured to introduce water into the internal flow channel. The water disinfection device comprises a fluid outlet configured to discharge treated water from the internal flow channel. The water disinfection device comprises an electrical circuit configured to selectively apply a first voltage having a first polarity to cause electrodeposition of copper from the tubular outer electrode onto the stainless steel wire core and a second voltage having a second polarity opposite the first polarity to cause ionization of copper from the copper shell.

According to other aspects of the present disclosure, the water disinfection device may include one or more of the following features. The wire of the core-shell center electrode may comprise stainless steel and the shell of the core-shell center electrode may comprise copper. The copper shell may have a thickness between 15 and 20 micrometers when electrodeposited onto the stainless steel wire core. The electrical circuit may be configured to apply the first voltage at a current density of 30-50 milliamperes per square centimeter during electrodeposition. The electrodeposition may be performed for a duration of approximately 20-40 minutes to achieve a desired copper shell thickness. The electrical circuit may be configured to apply the second voltage at a current of 0.1-1.0 milliamperes during copper ionization to produce copper ions at a concentration between 400 and 520 micrograms per liter. The copper ionization may operate in multiple phases comprising a controlled release phase, an extended release phase, and a self-cleaning phase.

According to another aspect of the present disclosure, a method of disinfecting water is provided. The method comprises providing a water disinfection system comprising a cylindrical outer electrode, a center electrode positioned within the cylindrical outer electrode and comprising an inner wire and an outer shell, and a voltage source. The method comprises applying a first voltage having a first polarity across the cylindrical outer electrode and the center electrode to electrodeposit metal from the cylindrical outer electrode onto the outer shell. The method comprises reversing polarity and applying a second voltage having a second polarity opposite the first polarity across the cylindrical outer electrode and the center electrode to ionize metal from the outer shell. The method comprises flowing water through the water disinfection system during application of the second voltage to disinfect the water with the ionized metal.

According to other aspects of the present disclosure, the method may include one or more of the following features. The cylindrical outer electrode may comprise copper and the inner wire may comprise stainless steel. The outer shell may comprise copper electrodeposited from the cylindrical outer electrode. Applying the first voltage may comprise applying a current density of 30-50 milliamperes per square centimeter for approximately 20-40 minutes. Applying the second voltage may comprise applying a current of 0.1-1.0 milliamperes to produce copper ions at a concentration between 400 and 520 micrograms per liter in the water. The ionization may operate through multiple phases comprising a controlled release phase, an extended release phase, and a self-cleaning phase that removes residual copper oxide from the inner wire.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A illustrates a system diagram of a water disinfection device with a coaxial electrode configuration, according to aspects of the present disclosure.

FIG. 1B illustrates cross-sectional views of the water disinfection device of FIG. 1A, according to aspects of the present disclosure.

FIG. 1C illustrates scanning electron microscope images and energy-dispersive X-ray spectroscopy analysis comparing a stainless steel wire and a stainless steel wire with a copper coating, according to aspects of the present disclosure.

FIG. 1D provides plots of diameter of stainless steel wire with a copper coating at various points and across different batches following in situ deposition, according to aspects of the present disclosure.

FIG. 2 depicts a graph showing theoretical and actual thickness of a wire electrode plotted against deposition time, according to aspects of the present disclosure.

FIG. 3A provides a schematic diagram of an exemplary water disinfection device showing diameter and length, according to aspects of the present disclosure.

FIG. 3B depicts diameter of an exemplary stainless steel wire, according to aspects of the present disclosure.

FIG. 3C depicts diameter of an exemplary pure copper wire, according to aspects of the present disclosure.

FIG. 4 illustrates a cross-sectional scanning electron microscope image of a wire electrode obtained through an electrodeposition process, according to aspects of the present disclosure.

FIG. 5A provides a plot showing copper ionization using pure copper wire and stainless steel wire with a copper coating, according to aspects of the present disclosure.

FIG. 5B depicts a bar graph comparing bacterial concentration using pure copper wire and stainless steel wire with a copper coating, across different current levels, according to aspects of the present disclosure.

FIG. 5C depicts a graph showing voltage changes for pure copper wire during operation from different batches, according to aspects of the present disclosure.

FIG. 5D depicts voltage changes for stainless steel wire with a copper coating during operation from different batches, according to aspects of the present disclosure.

FIG. 5E depicts a graph showing copper ion concentration and time relationship in effluent for stainless steel wire with copper coating during operation, according to aspects of the present disclosure.

FIG. 6 depicts a graph showing correlation between theoretical copper ion concentration and actual copper ion concentration, according to aspects of the present disclosure.

FIG. 7A depicts the graph showing correlation between applied current and the voltage across two electrodes, according to aspects of the present disclosure.

FIG. 7B depicts an electric field profile on the cross-section of an exemplary device, simulated using COMSOL Multiphysics at a voltage of 0.5V, according to aspects of the present disclosure.

FIG. 8A presents scanning electron microscope images of a fresh copper wire at two different magnifications, according to aspects of the present disclosure.

FIG. 8B provides a schematic diagram illustrating the copper wire of FIG. 8A with designated measurement positions, according to aspects of the present disclosure.

FIG. 8C provides scanning electron microscope images showing wire electrodes after ionization at a first position, according to aspects of the present disclosure.

FIG. 8D provides scanning electron microscope images showing wire electrodes after ionization at a second position, according to aspects of the present disclosure.

FIG. 8E provides scanning electron microscope images showing wire electrodes after ionization at a third position, according to aspects of the present disclosure.

FIG. 9 depicts a graph showing the relationship between effluent pH and time during operation, according to aspects of the present disclosure.

FIG. 10A depicts cross-sectional scanning electron microscope imaging and EDS analysis for freshly prepared wire, according to aspects of the present disclosure.

FIG. 10B depicts cross-sectional scanning electron microscope imaging and EDS analysis for wire after 10 hours ionization, according to aspects of the present disclosure.

FIG. 10C depicts cross-sectional scanning electron microscope imaging and EDS analysis for wire after 13 hours ionization, according to aspects of the present disclosure.

FIG. 10D depicts cross-sectional scanning electron microscope imaging and EDS analysis for wire after 18 hours ionization, according to aspects of the present disclosure.

FIG. 10E depicts cross-sectional scanning electron microscope imaging and EDS analysis for wire after 20 hours ionization, according to aspects of the present disclosure.

FIG. 10F depicts schematic illustration changes in the stainless steel wire with copper core-shell electrode over time, according to aspects of the present disclosure.

FIG. 11 depicts X-ray diffraction patterns of a copper oxide layer for a stainless steel wire with copper coating, according to aspects of the present disclosure.

FIG. 12 depicts a Pourbaix diagram of copper at a concentration of 500 µg/L, according to aspects of the present disclosure.

FIG. 13 depicts a cyclic voltammetry curve of an exemplary disinfection device using a pure stainless steel wire as the anode and a copper cylinder as the cathode.

FIG. 14 depicts a bar graph copper ion concentration detected in different optional phases, according to aspects of the present disclosure.

FIG. 15 depicts the bar graph comparing effluent pH values across different operational phases, according to aspects of the present disclosure.

FIG. 16 depicts a graph showing voltage changes over time during five consecutive cycles of electrodeposition, according to aspects of the present disclosure.

FIG. 17A depicts a graph showing voltage changes over time during five consecutive cycles of operation, according to aspects of the present disclosure.

FIG. 17B depicts a bar chart comparing duration of different operational phases across five consecutive cycles, according to aspects of the present disclosure.

FIG. 17C depicts scanning electron images for fresh stainless steel wire, according to aspects of the present disclosure.

FIG. 17D depicts scanning electron images for stainless steel wire after one cycle, according to aspects of the present disclosure.

FIG. 17E depicts scanning electron images for stainless steel wire after five cycles, according to aspects of the present disclosure.

FIG. 18 depicts a graph showing copper ion concentration changes during a self-cleaning phase under different current values, according to aspects of the present disclosure.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an”, and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

Water disinfection systems may utilize electrochemical processes to achieve microbial inactivation while avoiding the formation of harmful disinfection byproducts. A core-shell electrode configuration within a tubular device may provide enhanced disinfection performance through the combination of locally enhanced electric field treatment and metal ionization. The core-shell electrode may comprise a durable inner wire surrounded by an outer shell that undergoes electrochemical processes during operation.

The water disinfection system may operate through alternating electrodeposition and ionization processes. During electrodeposition, metal may be deposited from an outer electrode onto the core-shell center electrode to form or regenerate the outer shell. During ionization, the outer shell may release metal ions into the water stream to provide antimicrobial activity. This dual-phase operation may enable long-term system operation without requiring frequent system shutdown for electrode replacement.

The electrodeposition process may occur in situ within the tubular device, eliminating the need for system disassembly. An electrolyte solution may be introduced into the device, and a voltage may be applied to deposit metal from the outer electrode onto the center electrode. After electrodeposition, the electrolyte may be removed and water treatment may commence through the ionization process.

The water disinfection system may be scaled for various applications ranging from point-of-use household units to distributed community-scale clusters and centralized treatment plants. Small-scale implementations may serve individual households or buildings, while larger installations may treat water for entire communities or municipal systems. The modular design may allow for deployment at different scales based on treatment capacity requirements.

The system may be used for non-potable water treatment applications including decentralized treatment systems for swimming pools, complex buildings, hot water lines, and cooling towers. These applications may benefit from the residual disinfection properties provided by the metal ions, which may help prevent microbial regrowth and biofilm formation in distribution systems. The system may operate effectively in various water chemistries and flow conditions encountered in these diverse applications.

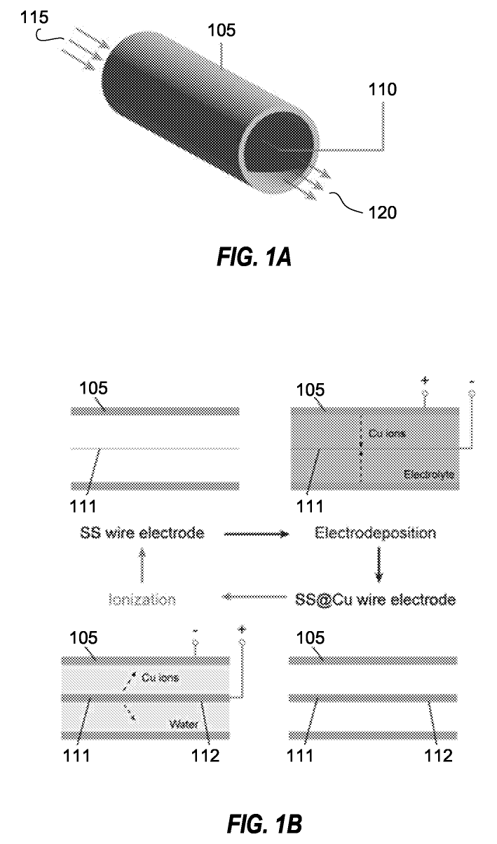

Referring to FIGS. 1A-1B, a system for disinfecting a fluid may comprise a coaxial electrode configuration that provides enhanced water treatment capabilities. The system may include a cylindrically-shaped outer electrode 105 that defines an internal cavity through which fluid flows during treatment. An outer electrode 105 may comprise copper, silver, or zinc, which may serve as antimicrobial metals for the electrochemical processes. The cylindrical geometry of the outer electrode 105 may provide uniform electric field distribution and consistent metal deposition characteristics throughout the treatment volume.

A center electrode 110 may be positioned within the internal cavity defined by the outer electrode 105. The center electrode 110 may extend along at least a portion of a longitudinal axis of the outer electrode 105, creating a coaxial arrangement that facilitates controlled electrochemical reactions. The center electrode 110 may comprise an inner wire 111 and an outer shell 112 surrounding the inner wire 111. The inner wire 111 may comprise stainless steel, which may provide structural stability and electrochemical durability during repeated operational cycles. The outer shell 112 may comprise copper, silver, or zinc, corresponding to the antimicrobial metal selected for the outer electrode 105.

As shown in FIGS. 1A-1B, an inlet may be positioned proximate a first end of the outer electrode 105 and may be configured to allow a fluid to pass from an area external to the cavity into the cavity. Influent 115 may enter the system through the inlet and flow through the internal cavity where the influent 115 may be exposed to the treatment processes. The coaxial electrode arrangement may create locally enhanced electric fields near the center electrode 110, which may facilitate both metal ionization and microbial inactivation.

An outlet 120 may be positioned proximate a second end of the outer electrode 105 and may be configured to allow the fluid to pass from the cavity into an area external to the cavity. The outlet 120 may discharge treated water after the fluid has been exposed to the antimicrobial metal ions and electric field treatment within the internal cavity. The flow path from the inlet through the cavity to the outlet 120 may provide sufficient residence time for effective disinfection while maintaining practical flow rates for various applications.

A voltage source may be configured to apply a voltage across the outer electrode 105 and the center electrode 110. The voltage source may selectively apply different polarities to achieve either electrodeposition or ionization processes. During electrodeposition, the outer electrode 105 may serve as an anode while the center electrode 110 may serve as a cathode, causing metal to deposit from the outer electrode 105 onto the outer shell 112. During ionization, the polarity may be reversed such that the center electrode 110 serves as an anode and releases metal ions from the outer shell 112 into the flowing water.

The water disinfection device may comprise a tubular outer electrode comprising copper and defining an internal flow channel. The tubular configuration may provide a compact design suitable for integration into existing water treatment systems. A core-shell center electrode may be positioned within the internal flow channel and may extend along a longitudinal axis of the tubular outer electrode. The core-shell center electrode may comprise a wire 111 core and a shell 112 electrodeposited onto the stainless steel wire 111 core, forming the dual-layer structure that enables the regenerative operation.

A fluid inlet may be configured to introduce water into the internal flow channel, while a fluid outlet may be configured to discharge treated water from the internal flow channel. An electrical circuit may be configured to selectively apply a first voltage having a first polarity to cause electrodeposition of copper from the tubular outer electrode onto the stainless steel wire core and a second voltage having a second polarity opposite the first polarity to cause ionization of copper from the copper shell. This dual-polarity operation may enable the system to regenerate the center electrode without requiring system disassembly or electrode replacement.

Referring to FIGS. 1C-1D, the core-shell electrode structure may undergo transformation from a bare stainless steel wire to a copper-coated wire through electrodeposition processes. The scanning electron microscope (SEM) images and energy-dispersive X-ray spectroscopy (EDS) analysis may demonstrate the successful formation of a uniform copper layer on the surface of the stainless steel substrate. The comparative analysis may show the elemental distribution before and after copper deposition, confirming the core-shell architecture of the center electrode.

The inner wire may comprise stainless steel and may have a diameter of approximately 50 micrometers in some cases. This diameter may be exemplary only, and the disclosure may not be limited to this specific value. Alternative diameters for the stainless steel wire may range from 25 to 100 micrometers, or from 40 to 75 micrometers, depending on the specific application requirements and desired electrochemical performance. The stainless steel composition may provide mechanical strength and electrochemical stability during repeated operational cycles.

The outer shell may comprise copper and may be formed through electrodeposition onto the stainless steel wire core. In some cases, the copper shell may have a thickness between 15 and 20 micrometers when electrodeposited onto the stainless steel wire core. This thickness range may be exemplary only, and the disclosure may not be limited to these specific values. Alternative thickness ranges for the copper shell may include 10 to 30 micrometers, or 12 to 25 micrometers, depending on the desired copper loading and operational duration requirements.

As shown in FIGS. 1C-1D, the EDS analysis may reveal the elemental composition and distribution within the core-shell structure. The iron (Fe) mapping may show strong signal intensity in the stainless steel wire core, while the copper (Cu) mapping may demonstrate uniform distribution across the outer shell region. The transformation from bare stainless steel to copper-coated wire may be clearly visible through the contrast differences in the SEM images and the corresponding elemental maps.

The electrodeposition process may achieve an average thickness of approximately 81.15 micrometers for the overall wire diameter after copper coating. This average thickness may be exemplary only, and the disclosure may not be limited to this specific value. Alternative average thicknesses may range from 70 to 95 micrometers, or from 75 to 90 micrometers, depending on the deposition conditions and target specifications. The spatial variation across the wire length may be approximately 8.5%, indicating uniform copper distribution along the electrode surface. This spatial variation may be exemplary only, with alternative spatial variations potentially ranging from 5% to 15%, or from 6% to 12%.

The batch-to-batch variation in the electrodeposition process may be approximately 1%, demonstrating reproducible manufacturing control. This batch-to-batch variation may be exemplary only, with alternative variations potentially ranging from 0.5% to 3%, or from 0.8% to 2%. The low variation values may indicate consistent process parameters and reliable electrode fabrication for commercial applications.

The outer electrode may have specific dimensions that facilitate the electrodeposition process and subsequent water treatment operations. In some cases, the outer electrode may have an inner diameter of approximately 7.5 millimeters and a length of approximately 21.5 centimeters, providing a total internal volume of approximately 9.5 milliliters. These dimensions may be exemplary only, and the disclosure may not be limited to these specific values. Alternative inner diameters may range from 5 to 15 millimeters, or from 6 to 10 millimeters, while alternative lengths may range from 15 to 30 centimeters, or from 18 to 25 centimeters, depending on the treatment capacity and flow rate requirements.

The electrodeposition process may involve the application of a first voltage having a first polarity to facilitate metal deposition from the outer electrode onto the outer shell of the center electrode. During this process, the outer electrode may serve as an anode while the center electrode may function as a cathode, creating the electrochemical conditions for metal transfer. The electrodeposition may occur in situ within the tubular device, eliminating the need for system disassembly or external electrode preparation.

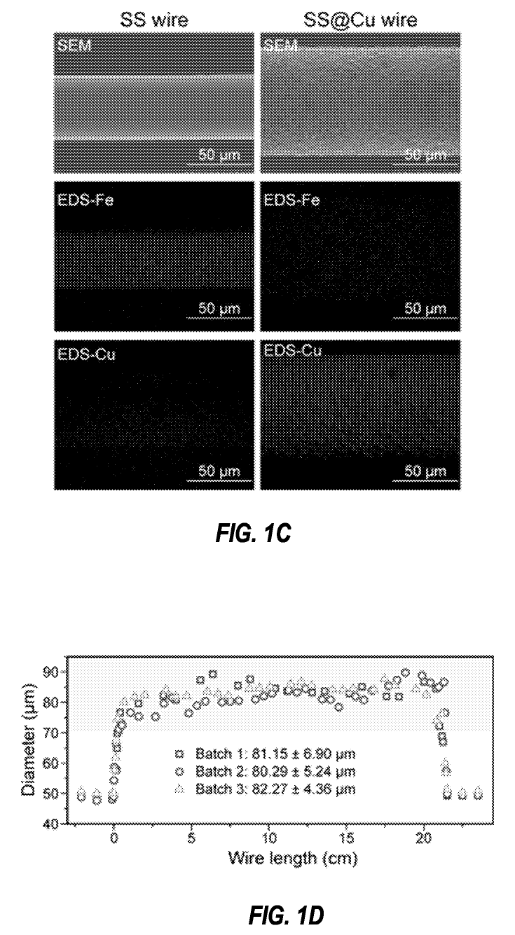

Referring to FIG. 2, the electrodeposition process may demonstrate a relationship between theoretical and actual thickness development over time. The theoretical thickness values may be calculated based on Faraday's law of electrolysis, while actual thickness measurements may be obtained through direct observation. The actual thickness may closely track the theoretical values but may remain slightly below the predicted thickness due to electrochemical inefficiencies and side reactions during the deposition process.

The electrodeposition process may achieve a coulombic efficiency of approximately 85.2% under standard operating conditions. This coulombic efficiency value may be exemplary only, and the disclosure may not be limited to this specific value. Alternative coulombic efficiency values may range from 80% to 95%, or from 82% to 90%, depending on the electrolyte composition, current density, and operating temperature. The coulombic efficiency may indicate the proportion of electrical charge that contributes to the desired metal deposition reaction versus side reactions such as hydrogen evolution or oxide formation.

The electrical circuit may be configured to apply the first voltage at a current density of approximately 40 milliamperes per square centimeter during electrodeposition. This current density value may be exemplary only, and the disclosure may not be limited to this specific value. The electrical circuit may be configured to apply the first voltage at a current density of 30-50 milliamperes per square centimeter during electrodeposition in various implementations. Alternative current density ranges may include 25 to 60 milliamperes per square centimeter, or 35 to 45 milliamperes per square centimeter, depending on the desired deposition rate and surface quality requirements.

The current density of 40 milliamperes per square centimeter may correspond to a current of approximately 13.5 milliamperes on a stainless steel wire having a diameter of 50 micrometers. This current value may be exemplary only, and the disclosure may not be limited to this specific value. Alternative current values may range from 10 to 20 milliamperes, or from 12 to 16 milliamperes, depending on the wire diameter and surface area calculations.

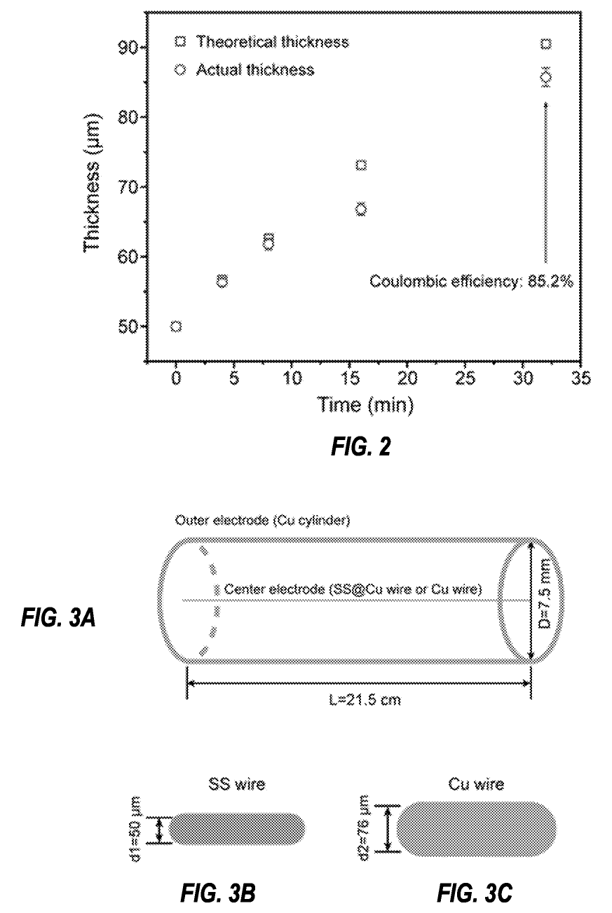

Referring to FIG. 3B, the electrodeposition may be performed for a duration of approximately 32 minutes to achieve a desired copper shell thickness. This duration value may be exemplary only, and the disclosure may not be limited to this specific value. The electrodeposition may be performed for a duration of approximately 20-40 minutes to achieve a desired copper shell thickness in various implementations. Alternative duration ranges may include 15 to 50 minutes, or 25 to 35 minutes, depending on the target thickness and current density parameters.

The electrodeposition process may utilize an electrolyte solution comprising copper sulfate at a concentration of approximately 160 grams per liter and sulfuric acid at a concentration of approximately 40 grams per liter. These concentration values may be exemplary only, and the disclosure may not be limited to these specific values. Alternative copper sulfate concentrations may range from 120 to 200 grams per liter, or from 140 to 180 grams per liter, while alternative sulfuric acid concentrations may range from 30 to 60 grams per liter, or from 35 to 50 grams per liter, depending on the desired deposition characteristics and electrolyte stability.

The electrodes may be secured at both ends with acrylic modules that include plugs for electrical connections. The acrylic modules may provide mechanical support and electrical isolation while allowing for precise positioning of the center electrode within the outer electrode. The acrylic modules may be connected to a potentiostat that controls the electrodeposition and ionization processes through programmable voltage and current parameters.

The electrodeposition process may be enhanced through the use of higher current densities with appropriate electrolyte additives. The current density may be increased to approximately 160 milliamperes per square centimeter to achieve high-speed copper electrodeposition when suitable additives are incorporated into the electrolyte solution. This enhanced current density value may be exemplary only, and the disclosure may not be limited to this specific value. Alternative high-speed current densities may range from 120 to 200 milliamperes per square centimeter, or from 140 to 180 milliamperes per square centimeter, depending on the additive composition and desired deposition rate.

The electrolyte additives for high-speed electrodeposition may include organic compounds that modify the copper deposition kinetics and surface morphology. These additives may enable higher current densities while maintaining uniform copper distribution and acceptable surface quality. The use of additives may reduce the electrodeposition duration while achieving comparable or improved copper shell characteristics compared to standard electrodeposition conditions.

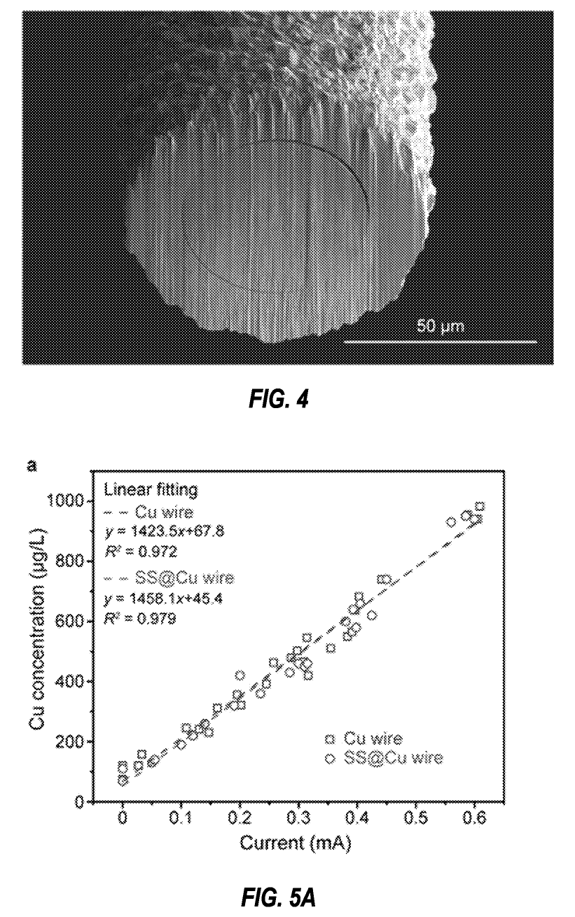

Referring to FIG. 4, cross-sectional analysis of the wire electrode may reveal the internal structure and material distribution following the electrodeposition process. The cross-sectional view may be prepared using focused ion beam milling techniques to expose the internal architecture without introducing artifacts from mechanical sectioning methods. The circular geometry of the wire cross-section may display distinct material layers that correspond to the core-shell electrode configuration.

The cross-sectional image may show a core region surrounded by an outer layer, with contrast differences indicating the material boundaries between the stainless steel substrate and the deposited copper layer. The core region may exhibit uniform composition and density characteristics typical of stainless steel, while the outer layer may display the granular morphology associated with electrochemically deposited copper. The interface between the core and shell materials may appear as a distinct boundary that defines the extent of copper penetration into the substrate surface.

The outer surface of the cross-sectioned wire may exhibit a textured, granular morphology that reflects the electrochemical deposition process. This surface texture may result from the formation of individual copper crystallites that coalesce during the deposition process. The granular structure may provide increased surface area compared to a smooth surface, which may enhance the subsequent ionization process by providing more sites for electrochemical reactions.

The cross-sectional analysis may provide dimensional measurements that confirm the thickness of the deposited copper layer. The scale reference may indicate that the overall wire diameter measures approximately 50 micrometers, which may correspond to the target dimensions for the core-shell electrode. The copper layer thickness may be determined by measuring the distance from the core-shell interface to the outer surface at multiple locations around the circumference.

The uniformity of the copper shell may be assessed through cross-sectional examination at different positions along the wire length. Variations in shell thickness may indicate non-uniform deposition conditions or electrolyte distribution within the tubular device. The cross-sectional analysis may reveal whether the electrodeposition process achieves consistent copper coverage across the entire electrode surface or whether localized variations occur due to geometric or electrochemical factors.

The internal structure revealed through cross-sectional analysis may demonstrate the effectiveness of the in situ electrodeposition process for creating the core-shell electrode configuration. The distinct material layers and well-defined interface may indicate successful copper deposition without significant intermixing or diffusion between the core and shell materials. This structural integrity may be important for maintaining the electrochemical performance and mechanical stability of the electrode during subsequent ionization cycles.

The ionization process may commence following the electrodeposition phase through the application of a second voltage having a second polarity opposite the first polarity used during electrodeposition. During ionization, the center electrode may serve as an anode while the outer electrode may function as a cathode, reversing the electrochemical configuration from the deposition process. This polarity reversal may cause metal ions to be released from the outer shell into the flowing water, providing antimicrobial activity for water disinfection.

The electrical circuit may be configured to apply the second voltage at a current of approximately 0.3 milliamperes during copper ionization to produce copper ions at concentrations between 450 and 520 micrograms per liter in the fluid. This current value may be exemplary only, and the disclosure may not be limited to this specific value. The electrical circuit may be configured to apply the second voltage at a current of 0.1-1.0 milliamperes during copper ionization to produce copper ions at a concentration between 400 and 520 micrograms per liter in various implementations. Alternative current ranges may include 0.05 to 1.5 milliamperes, or 0.2 to 0.8 milliamperes, depending on the desired copper ion concentration and flow rate conditions.

The system voltage during ionization may initially operate at approximately 0.5 volts when the current is maintained at 0.3 milliamperes. This initial voltage value may be exemplary only, and the disclosure may not be limited to this specific value. Alternative initial voltage values may range from 0.3 to 0.8 volts, or from 0.4 to 0.6 volts, depending on the electrode surface area and electrolyte conductivity. The voltage may remain stable at this level for approximately 10 to 12 hours during normal operation before gradually increasing to approximately 1.8 volts during extended operational phases.

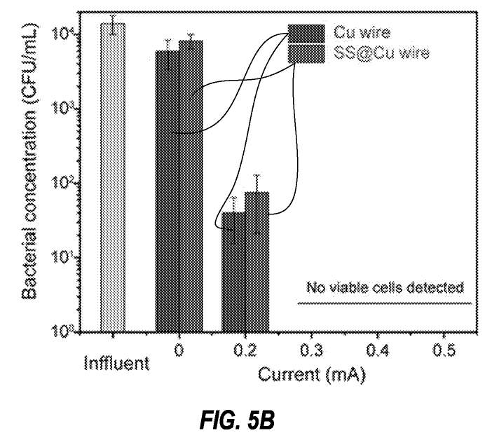

Referring to FIG. 5B, the bacterial disinfection performance may demonstrate effective microbial inactivation across different current levels. The bacterial concentration measurements may show that at current levels of 0.3 milliamperes and above, no active bacterial cells may be detected in the effluent. At lower current levels such as 0.2 milliamperes, the bacterial concentration may be reduced from approximately 10⁴ colony-forming units per milliliter in the influent to approximately 10² colony-forming units per milliliter in the effluent, indicating partial disinfection effectiveness.

The copper ion concentrations produced during ionization may remain below the maximum contaminant level goal of 1.3 milligrams per liter established by regulatory agencies for drinking water applications. The concentration range of 450 to 520 micrograms per liter may provide effective antimicrobial activity while maintaining compliance with water quality standards. This concentration range may be exemplary only, with alternative effective concentration ranges potentially including 350 to 650 micrograms per liter, or 400 to 600 micrograms per liter, depending on the target microorganisms and water chemistry conditions.

The ionization process may achieve a copper utilization efficiency of approximately 101.1% for the core-shell electrode configuration. This utilization efficiency value may be exemplary only, and the disclosure may not be limited to this specific value. Alternative utilization efficiency values may range from 95% to 105%, or from 98% to 103%, depending on the operational conditions and electrode surface characteristics. The high utilization efficiency may indicate near-complete release of the deposited copper from the outer shell during the ionization process.

In comparison, pure copper wire electrodes may achieve copper utilization efficiencies ranging from approximately 21.2% to 53.8% under similar operational conditions. These comparative efficiency values may be exemplary only, and the disclosure may not be limited to these specific values. Alternative comparative efficiency ranges for pure copper wire may include 15% to 65%, or 25% to 50%, depending on the wire diameter and surface treatment. The significantly higher utilization efficiency of the core-shell electrode may result from the structural stability provided by the stainless steel core, which may prevent premature electrode failure due to pitting corrosion.

Referring to FIG. 5E, the copper ion concentration in the effluent may remain stable at approximately 400 to 500 micrograms per liter for up to 20 hours of continuous operation. This operational duration may be exemplary only, and the disclosure may not be limited to this specific value. Alternative operational durations may range from 15 to 25 hours, or from 18 to 22 hours, depending on the copper shell thickness and current density parameters. Following this stable release period, the copper ion concentration may begin to decline and may return to influent levels after an additional 5 to 6 hours of operation.

The operational voltage may exhibit distinct phases during the ionization process, with the voltage remaining stable at approximately 0.5 volts for the first 10 to 12 hours before gradually increasing to approximately 1.8 volts at 16 to 18 hours. This voltage progression may be exemplary only, with alternative voltage ranges potentially including 0.3 to 0.7 volts for the initial stable phase and 1.5 to 2.0 volts for the extended phase. The voltage increase may correspond to changes in the electrode surface area available for ionization as the copper shell undergoes consumption during the disinfection process.

The system may maintain consistent disinfection performance across different batches of core-shell electrodes, demonstrating reproducible operational characteristics. The voltage profiles and copper ion release patterns may exhibit minimal variation between different electrode preparations, indicating reliable manufacturing control and predictable performance for commercial applications. The consistency in operational parameters may enable automated control systems to monitor and adjust the ionization process based on voltage and concentration feedback signals.

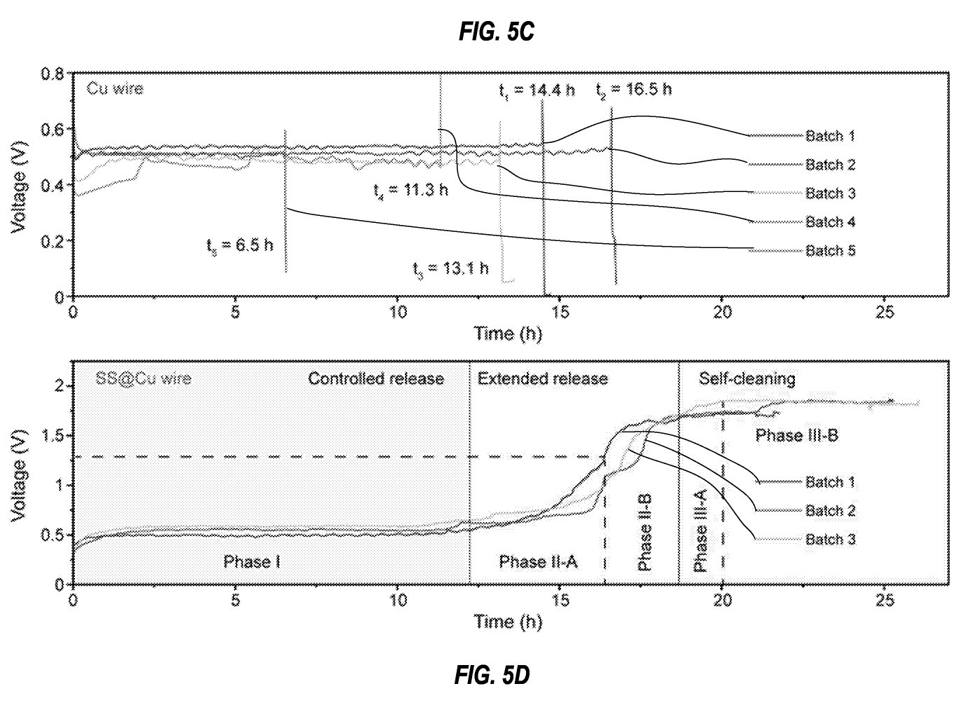

Referring to FIG. 6, the ionization efficiency may be characterized through the correlation between theoretical and actual copper ion concentrations during the electrochemical process. The theoretical copper ion concentrations may be calculated based on Faraday's law of electrolysis, which may predict the amount of copper that should be released for a given current and time duration. The actual copper ion concentrations may be measured through analytical techniques such as atomic absorption spectrometry or colorimetric methods to determine the real-world performance of the ionization process.

The correlation between theoretical and actual copper ion concentrations may follow a linear relationship described by the equation y = 0.765x, where y represents the actual copper ion concentration and x represents the theoretical copper ion concentration. This linear relationship may be exemplary only, and the disclosure may not be limited to this specific equation. Alternative linear relationships may include coefficients ranging from 0.7 to 0.85, or from 0.72 to 0.8, depending on the electrode surface conditions and electrolyte composition. The linear correlation may demonstrate a strong statistical relationship with an R² value of approximately 0.991.

The R² value of 0.991 may indicate that approximately 99.1% of the variance in actual copper ion concentrations may be explained by the theoretical predictions based on electrochemical principles. This R² value may be exemplary only, and the disclosure may not be limited to this specific value. Alternative R² values may range from 0.98 to 0.995, or from 0.985 to 0.993, depending on the measurement precision and experimental conditions. The high R² value may demonstrate the predictability and consistency of the ionization process across different operational parameters.

The slope coefficient of 0.765 in the linear relationship may correspond to a coulombic efficiency of approximately 76.5% for the ionization process. This coulombic efficiency value may be exemplary only, and the disclosure may not be limited to this specific value. Alternative coulombic efficiency values may range from 70% to 85%, or from 72% to 80%, depending on the electrode surface morphology and operating conditions. The coulombic efficiency may indicate that approximately 76.5% of the electrical charge applied during ionization may contribute to copper ion release, while the remaining charge may be consumed by side reactions.

The side reactions that may account for the difference between theoretical and actual copper ion concentrations may include the formation of copper oxides on the electrode surface, hydrogen evolution at the cathode, and oxygen reduction reactions. These side reactions may consume electrical charge without contributing to the desired copper ionization process, thereby reducing the overall coulombic efficiency. The formation of copper oxides may be particularly significant, as these compounds may remain on the electrode surface rather than dissolving into the water stream.

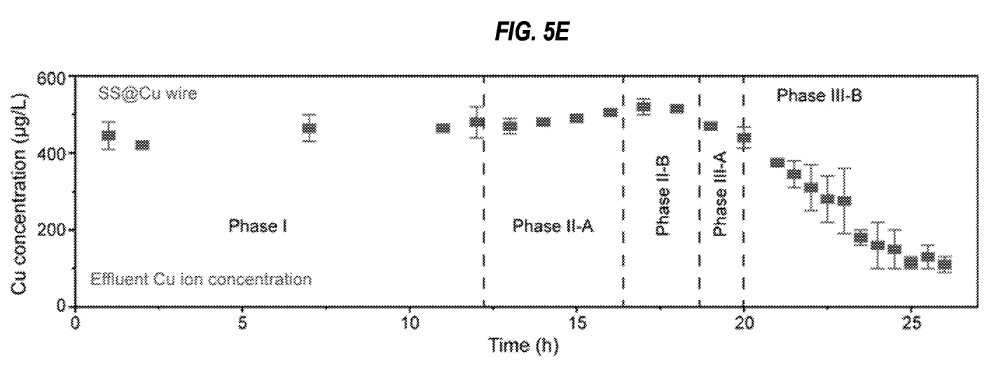

Referring to FIG. 7A, the correlation between applied current and voltage across the electrodes may demonstrate the electrical characteristics of the ionization system. The voltage may increase proportionally with the applied current, following Ohm's law relationships that may be modified by the electrochemical reactions occurring at the electrode surfaces. The voltage-current relationship may provide information about the system resistance and the onset of different electrochemical processes as the current density increases.

The voltage measurements may range from approximately 0.3 volts at low current levels to approximately 1.5 volts at higher current levels during normal ionization operation. These voltage ranges may be exemplary only, and the disclosure may not be limited to these specific values. Alternative voltage ranges may include 0.2 to 0.5 volts at low current levels and 1.2 to 1.8 volts at higher current levels, or 0.25 to 0.45 volts and 1.3 to 1.7 volts respectively, depending on the electrode surface area and electrolyte conductivity.

Referring to FIG. 7B, the electric field distribution may be simulated using computational methods such as COMSOL Multiphysics software to analyze the field enhancement characteristics near the center electrode. The simulation may be performed at a voltage of approximately 0.5 volts to represent typical operational conditions during the ionization process. This simulation voltage may be exemplary only, and the disclosure may not be limited to this specific value. Alternative simulation voltages may range from 0.3 to 0.8 volts, or from 0.4 to 0.6 volts, depending on the operational parameters being analyzed.

The electric field simulation may reveal significant field enhancement in the vicinity of the center electrode compared to regions near the outer electrode. The field enhancement may result from the coaxial geometry and the small diameter of the center electrode, which may concentrate the electric field lines in the immediate vicinity of the copper shell surface. This localized field enhancement may facilitate both the ionization process and the electrophoretic transport of microorganisms toward the center electrode where copper ion concentrations may be highest.

The electric field strength near the center electrode may be several times higher than the average field strength across the electrode gap. The field enhancement factor may range from approximately 3 to 10 times the average field strength, depending on the electrode diameter ratio and geometric configuration. These field enhancement values may be exemplary only, and the disclosure may not be limited to these specific ranges. Alternative field enhancement factors may include 2 to 15 times the average field strength, or 4 to 8 times the average field strength, depending on the specific electrode dimensions and spacing parameters.

The locally enhanced electric field may contribute to the disinfection mechanism through electroporation effects on microbial cell membranes. The high field strength near the center electrode may increase membrane permeability, allowing copper ions to penetrate more effectively into microbial cells and cause irreversible damage. This synergistic effect between electric field treatment and copper ionization may enable effective disinfection at lower copper concentrations than would be required for copper ionization alone.

The electric field distribution may also influence the transport of copper ions away from the center electrode surface through electrokinetic effects. The field gradients may create electrophoretic forces that may enhance the mixing and distribution of copper ions throughout the treatment volume. This enhanced transport may improve the contact between copper ions and microorganisms, potentially increasing the overall disinfection efficiency of the system.

The computational simulation may account for the effects of fluid flow on the electric field distribution, as the flowing water may influence the current density distribution and local field strengths. The flow velocity profile within the tubular device may create variations in residence time and copper ion exposure that may affect the overall disinfection performance. The simulation results may be validated through experimental measurements of copper ion concentrations at different radial positions within the treatment volume.

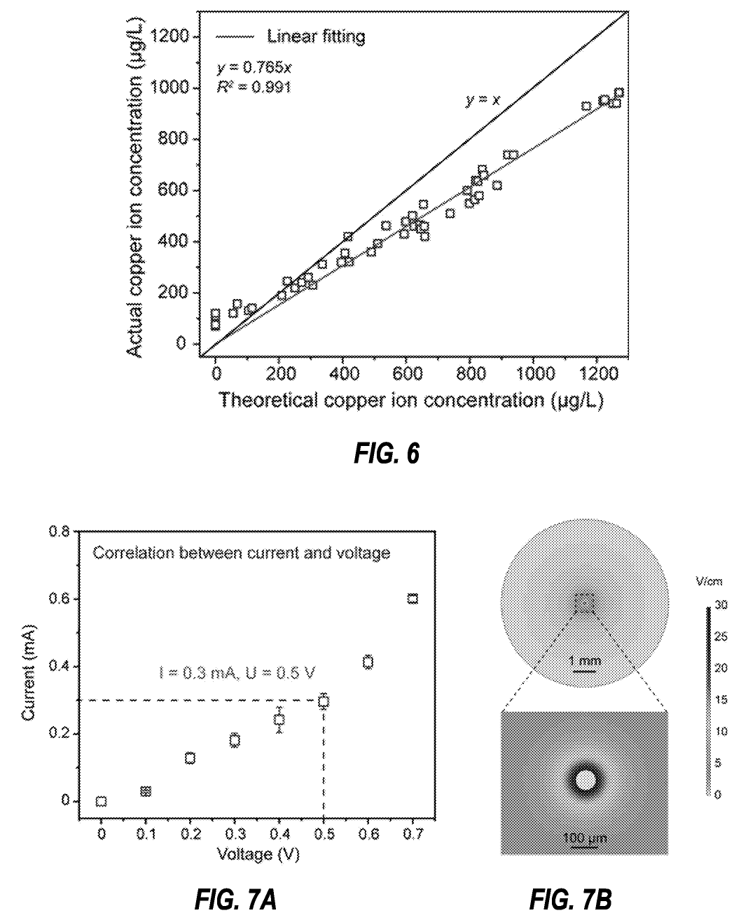

Referring to FIG. 8A, the surface morphology of a fresh copper wire may be characterized through scanning electron microscope analysis at multiple magnification levels. The lower magnification view may reveal the overall cylindrical geometry of the wire with a measured diameter of approximately 76.2 micrometers. This diameter measurement may be exemplary only, and the disclosure may not be limited to this specific value. Alternative wire diameters may range from 60 to 90 micrometers, or from 70 to 85 micrometers, depending on the manufacturing specifications and application requirements.

As shown in FIG. 8B, the wire electrode may be analyzed at multiple positions along its length to assess variations in surface morphology and structural integrity. The schematic representation may identify three specific measurement positions designated as Position 1, Position 2, and Position 3, which may be distributed along the wire length to provide representative sampling of the electrode surface characteristics.

Referring to FIG. 8C, the surface morphology analysis at Position 1 may reveal significant changes in wire diameter and surface characteristics compared to the fresh wire condition. The wire diameter at Position 1 may measure approximately 14.8 micrometers, representing a substantial reduction from the original wire diameter. This diameter reduction may be exemplary only, and the disclosure may not be limited to this specific value. Alternative diameter measurements at Position 1 may range from 10 to 25 micrometers, or from 12 to 20 micrometers, depending on the extent of electrochemical consumption and the duration of ionization operation.

The cross-sectional view at Position 1 may display a wire structure with a relatively smooth outer contour despite the significant diameter reduction. The surface morphology at higher magnification may exhibit a granular texture with numerous small particles distributed across the surface. These particles may represent copper oxide formations or residual copper deposits that may remain on the wire surface following the ionization process. The granular structure may create a rough microstructure that may differ significantly from the original smooth wire surface.

Referring to FIG. 8D, the analysis at Position 2 may show a wire diameter of approximately 30.1 micrometers, indicating an intermediate level of electrochemical consumption compared to Position 1. This diameter measurement may be exemplary only, and the disclosure may not be limited to this specific value. Alternative diameter measurements at Position 2 may range from 25 to 40 micrometers, or from 28 to 35 micrometers, depending on the local electrochemical conditions and current density distribution along the wire length.

Referring to FIG. 8E, the wire diameter at Position 3 may measure approximately 77.1 micrometers, which may be similar to or slightly larger than the original fresh wire diameter. This diameter measurement may be exemplary only, and the disclosure may not be limited to this specific value. Alternative diameter measurements at Position 3 may range from 70 to 85 micrometers, or from 74 to 82 micrometers, depending on the local electrochemical conditions and the extent of surface modification during operation.

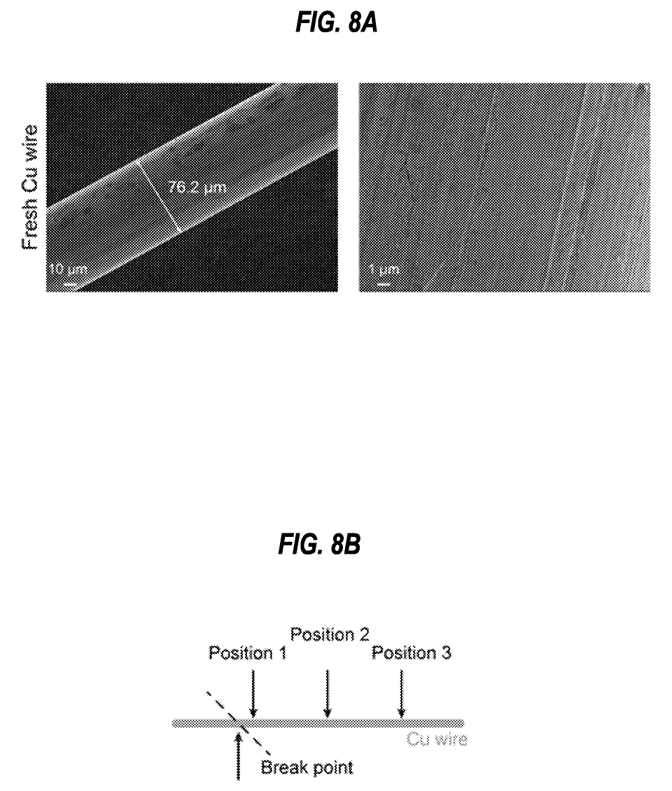

Referring to FIG. 9, the pH monitoring during operation may demonstrate the system's effect on water chemistry throughout the disinfection process. The effluent pH measurements may be tracked over time to assess the electrochemical reactions occurring at both the anode and cathode during copper ionization. The pH monitoring may provide insights into the stability of the water treatment process and the potential for secondary chemical effects that may influence disinfection performance.

The effluent pH may remain relatively stable at approximately 6.31 during the initial operational period, which may extend for approximately the first 20 hours of continuous operation. This stable pH value may be exemplary only, and the disclosure may not be limited to this specific value. Alternative stable pH values may range from 6.0 to 6.6, or from 6.2 to 6.4, depending on the influent water chemistry and the specific electrochemical conditions within the treatment device. The pH stability during this initial period may indicate balanced electrochemical reactions at the electrode surfaces. As shown in FIG. 9, the effluent pH may begin to decrease after approximately 20 hours of operation, indicating a shift in the electrochemical balance within the system.

The influent pH may serve as a baseline reference for comparison with the effluent pH measurements throughout the operational cycle. The influent pH may be indicated by a horizontal reference line that may show the initial water chemistry before electrochemical treatment. The difference between influent and effluent pH values may provide information about the extent of electrochemical modification of the water chemistry during the disinfection process.

The pH monitoring data may be used to optimize operational parameters such as current density and treatment duration to maintain desired water quality characteristics. The pH trends may serve as indicators for transitioning between different operational phases or for initiating electrode regeneration cycles. Automated control systems may utilize pH feedback signals in combination with other parameters such as voltage and copper ion concentration to maintain optimal disinfection performance while minimizing adverse effects on water chemistry.

The pH stability during the initial operational period may be important for maintaining the effectiveness of the copper ionization process, as pH conditions may influence the speciation and bioavailability of copper ions in the treated water. The relatively neutral pH range may favor the formation of cupric ions that may exhibit antimicrobial activity, while extreme pH conditions may promote the formation of copper hydroxide precipitates or other species that may be less effective for disinfection applications.

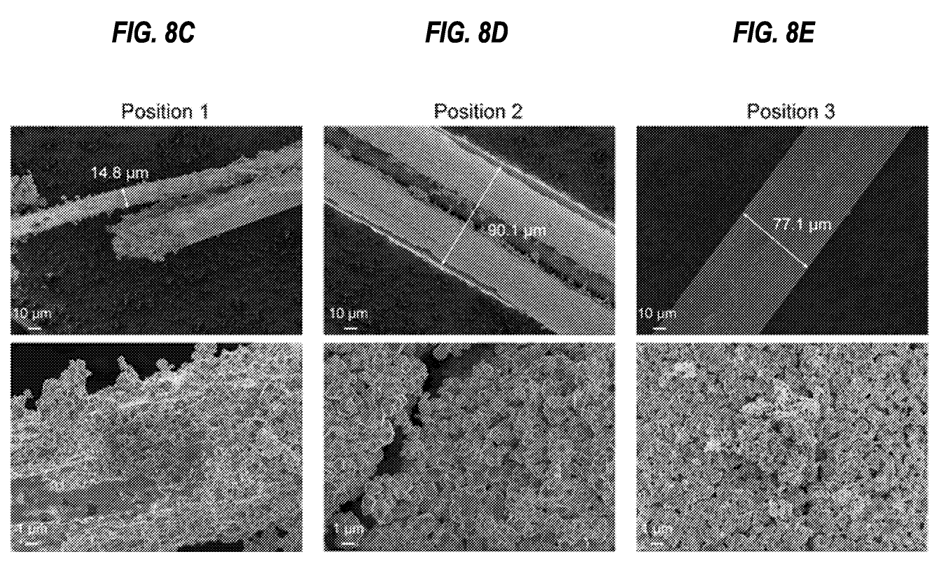

Referring to FIGS. 10A-10F, the life cycle of the core-shell electrode during water disinfection may be characterized through three distinct operational phases that may demonstrate the evolution of the electrode structure and electrochemical behavior over time. The electrode may undergo systematic changes in composition and morphology as the copper shell may be consumed through ionization processes and may subsequently regenerate through the self-cleaning mechanism. The schematic illustration may show the progression of the electrode from the initial core-shell configuration through various intermediate states to the final cleaned stainless steel core.

The ionization process may operate through three distinct phases comprising a controlled release phase, an extended release phase, and a self-cleaning phase. Phase I may be designated as the controlled release phase and may be characterized by stable voltage and copper ion concentration for approximately 10 to 12 hours of continuous operation. This operational duration may be exemplary only, and the disclosure may not be limited to this specific value. Alternative operational durations for Phase I may range from 8 to 15 hours, or from 9 to 13 hours, depending on the copper shell thickness and current density parameters.

During Phase I, the copper shell may undergo direct ionization to release copper ions into the flowing water while simultaneously forming copper oxide layers on the electrode surface. The voltage may remain stable at approximately 0.5 volts throughout this phase, indicating consistent electrochemical conditions and adequate copper surface area for the ionization reactions. The copper ion concentration may remain stable between approximately 400 and 500 micrograms per liter during Phase I, providing consistent antimicrobial activity for water disinfection applications.

As shown in FIGS. 10A-10F, the copper layer may begin to separate into two distinct sublayers during Phase I operation. The outer sublayer may contain significantly more oxygen than the inner sublayer, indicating the formation of copper oxides through electrochemical reactions with dissolved oxygen and hydroxide ions in the water. The formation of copper oxides may consume a portion of the electrical current that would otherwise contribute to copper ionization, thereby reducing the overall coulombic efficiency of the process.

The copper oxide formation may be characterized through X-ray diffraction analysis, which may reveal the formation of cuprous oxide (Cu₂O) with characteristic peaks at 2θ angles of approximately 29.4°, 36.2°, 42.1°, and 61.0°. These peak positions may be exemplary only, and the disclosure may not be limited to these specific values. Alternative peak positions for cuprous oxide may range from 29.0° to 29.8°, 35.8° to 36.6°, 41.7° to 42.5°, and 60.6° to 61.4° respectively, depending on the crystal structure and measurement conditions. The X-ray diffraction analysis may also reveal copper peaks at 2θ angles of approximately 43.1°, 50.2°, and 73.6°, which may correspond to metallic copper remaining in the inner sublayer.

The electrochemical reactions occurring during Phase I may include copper ionization at the anode according to the reaction Cu - 2e⁻ → Cu²⁺, which may release copper ions directly into the water stream. Simultaneously, copper oxide formation may occur through the reaction 2Cu + 2OH⁻ - 2e⁻ → Cu₂O + H₂O, which may consume copper from the shell while forming a porous oxide layer on the electrode surface. At the cathode, oxygen reduction may occur according to the reaction O₂ + 4H⁺ + 4e⁻ → 2H₂O, which may consume hydrogen ions and may contribute to the pH increase observed in the effluent water.

Phase II may be designated as the extended release phase and may be characterized by increasing voltage accompanied by stable copper ion concentration. Phase II may be subdivided into Phase II-A and Phase II-B based on the dominant electrochemical processes occurring during each sub-phase. The voltage may gradually increase from approximately 0.5 volts to approximately 1.8 volts during Phase II, reaching the higher voltage level at approximately 16 to 18 hours of operation. These voltage values may be exemplary only, and the disclosure may not be limited to these specific values. Alternative voltage ranges for Phase II may include 0.4 to 0.6 volts at the beginning and 1.5 to 2.0 volts at the end, or 0.45 to 0.55 volts and 1.6 to 1.9 volts respectively.

During Phase II-A, most areas of the stainless steel core may remain covered by both metallic copper and cuprous oxide layers, with only limited locations where the core may be directly covered by cuprous oxide alone. The voltage increase during Phase II-A may result from the reduction in effective copper surface area available for ionization as the copper shell may be consumed through the combined effects of direct ionization and oxide formation. The system may compensate for the reduced surface area by increasing the voltage to maintain the target current density for continued copper ion release.

The electrochemical reactions during Phase II-A may remain similar to those occurring in Phase I, with copper ionization and copper oxide formation continuing at locations where metallic copper may be available. The copper oxide layer may continue to thicken while the underlying copper layer may become progressively thinner as the electrochemical consumption proceeds. The balance between direct ionization and oxide formation may shift toward increased oxide formation as the available copper surface area may decrease.

Phase II-B may commence when copper ionization alone may become insufficient to maintain the target current of approximately 0.3 milliamperes due to the limited remaining copper surface area. During Phase II-B, water electrolysis may begin to contribute significantly to the total current, with the onset of substantial water hydrolysis occurring when the applied voltage may exceed approximately 1.27 volts. This voltage threshold may be exemplary only, and the disclosure may not be limited to this specific value. Alternative voltage thresholds for water electrolysis may range from 1.1 to 1.5 volts, or from 1.2 to 1.4 volts, depending on the electrode surface conditions and electrolyte composition.

During Phase II-B, copper ionization and water splitting may occur simultaneously but may be spatially separated across different regions of the electrode surface. In areas where copper shell may remain available, copper may continue to be oxidized according to the reactions Cu - 2e⁻ → Cu²⁺ and 2Cu + 2OH⁻ - 2e⁻ → Cu₂O + H₂O. In areas where the copper may have been fully converted to cuprous oxide, water splitting may dominate according to the reaction 2H₂O - 4e⁻ → O₂ + 4H⁺, producing hydrogen ions and creating localized acidic conditions.

The localized acidic conditions created during water splitting may facilitate the dissolution of cuprous oxide according to the reaction Cu₂O + O₂ + 4H⁺ → 2Cu²⁺ + 2H₂O. This dissolution process may release additional copper ions into the water stream, potentially resulting in slightly higher copper ion concentrations during Phase II-B compared to earlier operational phases. The dissolution of cuprous oxide may create gaps between the stainless steel core and the remaining oxide layer, as shown in the schematic progression of FIGS. 10A-10F.

Phase III may be designated as the self-cleaning phase and may be characterized by decreasing copper ion concentration after approximately 20 hours of operation. This transition time may be exemplary only, and the disclosure may not be limited to this specific value. Alternative transition times for Phase III may range from 18 to 24 hours, or from 19 to 22 hours, depending on the initial copper shell thickness and operational current density. Phase III may be subdivided into Phase III-A occurring at approximately 18 to 20 hours and Phase III-B occurring after 20 hours of operation.

During Phase III-A, copper ion concentrations may maintain at relatively stable levels due to the continued dissolution of cuprous oxide layers remaining on the electrode surface. The dissolution process may be driven by the localized production of hydrogen ions through water electrolysis, which may create the acidic conditions necessary for cuprous oxide solubilization. The gap between the stainless steel core and the oxide layer may become progressively larger as more cuprous oxide may dissolve and may be released into the water stream.

Phase III-B may commence when the majority of the cuprous oxide layer may have been dissolved, resulting in decreased copper ion concentrations in the effluent water. During Phase III-B, the produced hydrogen ions from water electrolysis may not be fully consumed by cuprous oxide dissolution, leading to a decrease in effluent pH and copper ion concentration. The duration of Phase III-B may extend for approximately 5 to 6 hours beyond the initial 20-hour operational period. This duration may be exemplary only, and the disclosure may not be limited to this specific value. Alternative durations for Phase III-B may range from 3 to 8 hours, or from 4 to 7 hours, depending on the amount of residual cuprous oxide and the water electrolysis rate.

The self-cleaning mechanism during Phase III may ultimately result in the complete consumption of the cuprous oxide layer and may expose the bare stainless steel core. This natural cleaning process may ensure that no residual copper or cuprous oxide may remain on the electrode surface, thereby preparing the stainless steel core for subsequent copper electrodeposition without requiring additional chemical or mechanical treatment. The self-cleaned stainless steel core may retain its original structural integrity and may be suitable for repeated electrodeposition and ionization cycles.

The progression through the three operational phases may demonstrate the complete utilization of the deposited copper shell, achieving copper utilization efficiencies approaching 100% compared to the significantly lower efficiencies observed with conventional pure copper wire electrodes. The systematic evolution from copper ionization through oxide formation and dissolution to final core cleaning may enable the regenerative operation that may distinguish the core-shell electrode configuration from conventional consumable electrode designs.

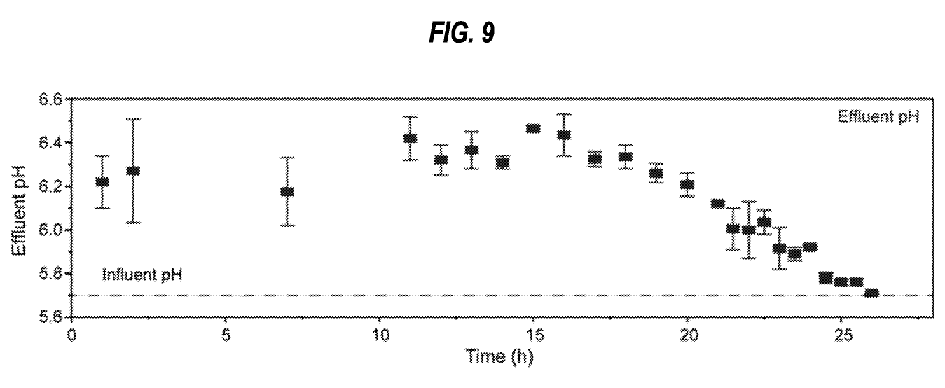

Referring to FIG. 11, The XRD pattern indicates the formation of cuprous oxide (Cu₂O), with characteristic peaks at 2θ=29.4^{o}, 36.2^{o}, 42.1^{o}, and 61.0^{o}, corresponding to Cu₂O, while peaks at 2θ=43.1^{o}, 50.2^{o}, and 73.6^{o} correspond to Cu.

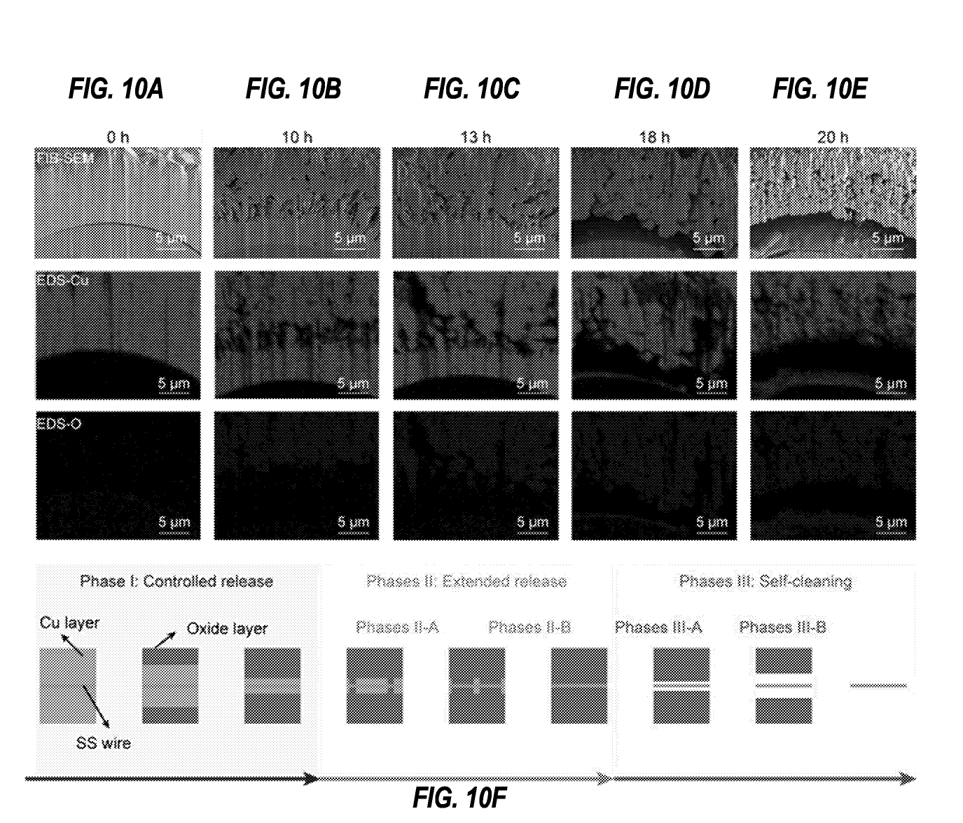

Referring to FIG. 12, the Pourbaix diagram indicates that at pH 6.3, both Cu²⁺ and Cu₂O may be generated, depending on the applied electrochemical potential, which correlates well with the Cu²⁺ and Cu₂O observed in the disinfection system.

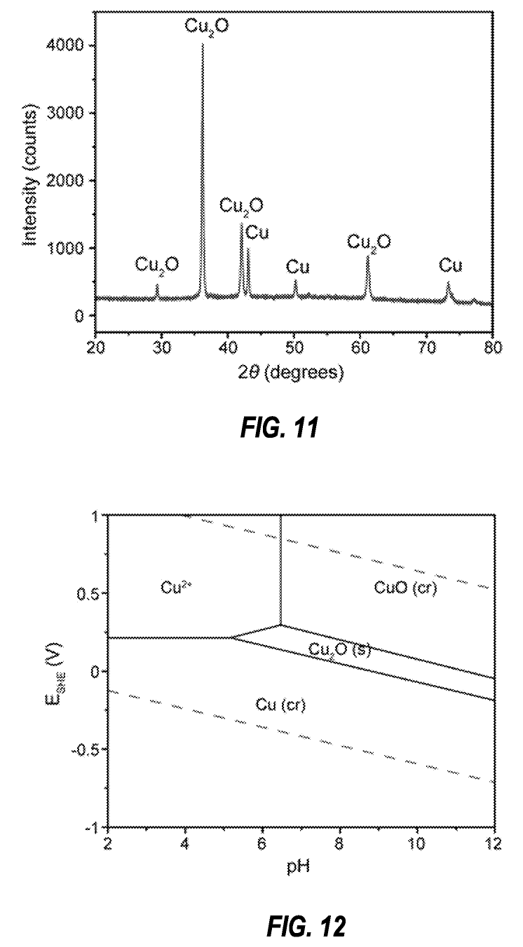

Referring to FIG. 13, cyclic voltammetry analysis may be performed using a pure stainless steel wire as the anode and a copper cylinder as the cathode to characterize the electrochemical behavior of the system under different voltage conditions. The cyclic voltammetry curve may demonstrate the relationship between applied voltage and current response, providing insights into the onset of various electrochemical processes including water electrolysis.

The cyclic voltammetry results may show that substantial water hydrolysis begins when the applied voltage exceeds approximately 1.27 volts, as indicated by a marked increase in current at voltages above this threshold. This voltage threshold may be exemplary only, and the disclosure may not be limited to this specific value. Alternative voltage thresholds for the onset of substantial water hydrolysis may range from 1.1 to 1.5 volts, or from 1.2 to 1.4 volts, depending on the electrode surface conditions, electrolyte composition, and pH of the solution.

The current response at voltages below the 1.27-volt threshold may remain relatively low, indicating minimal electrochemical activity other than background reactions such as oxygen reduction or trace metal oxidation. As the voltage approaches and exceeds the threshold value, the current may increase substantially, corresponding to the onset of water splitting reactions that produce hydrogen ions at the anode and hydrogen gas or additional reduction reactions at the cathode.

The hysteresis behavior observed in the cyclic voltammetry curve may indicate the presence of irreversible electrochemical processes and may demonstrate the different reaction pathways that may occur during forward and reverse voltage scans. The forward scan may show the progressive activation of electrochemical processes as the voltage increases, while the reverse scan may reveal the deactivation or modification of electrode surface conditions that may affect the current response.

The cyclic voltammetry analysis may provide validation for the voltage thresholds observed during the operational phases of the water disinfection system. The transition from Phase II-A to Phase II-B may correspond to the voltage range where water electrolysis begins to contribute significantly to the total current, as demonstrated by the cyclic voltammetry results. This correlation may support the mechanistic understanding of the electrode behavior during extended operation periods.

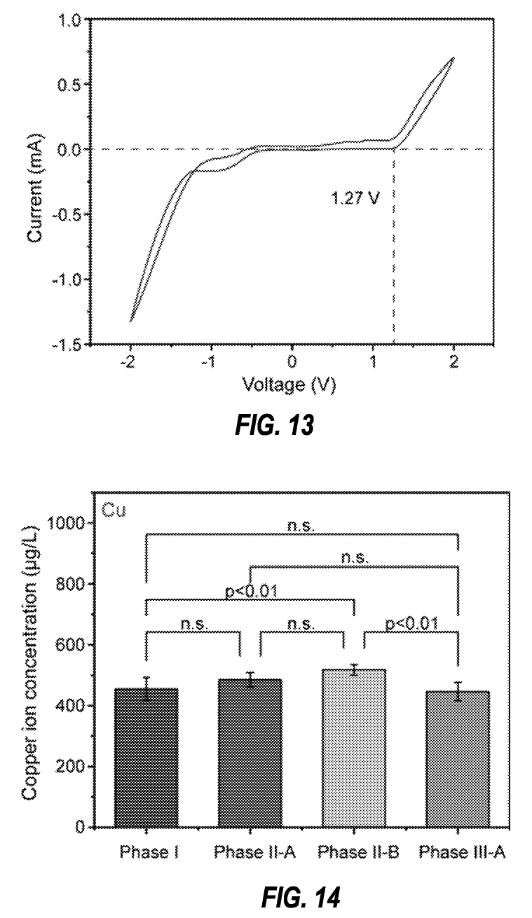

Referring to FIG. 14, the copper ion concentrations measured across the different operational phases may demonstrate the system's ability to maintain consistent antimicrobial metal delivery despite underlying changes in electrochemical mechanisms. During Phase I, the copper ion concentrations may remain stable at approximately 450 to 500 micrograms per liter, corresponding to the controlled release period where direct copper ionization may dominate the electrochemical processes. The stable copper ion output during Phase I may provide predictable disinfection performance while operating at voltages below the water electrolysis threshold identified in the cyclic voltammetry analysis.

The copper ion concentrations during Phase II-A may maintain similar levels to Phase I, ranging from approximately 440 to 510 micrograms per liter, indicating that the system may continue to provide consistent antimicrobial metal delivery even as the voltage begins to increase due to reduced copper surface area. The statistical analysis may indicate no significant differences between Phase I and Phase II-A copper ion concentrations, demonstrating the system's ability to compensate for changing electrode surface conditions through voltage adjustments while maintaining stable metal ion output.

During Phase II-B, the copper ion concentrations may show slight variations compared to earlier phases, with measurements potentially ranging from approximately 430 to 530 micrograms per liter. The copper ion levels during Phase II-B may reflect the combined contributions from direct copper ionization in areas where metallic copper may remain available and from acidic dissolution of copper oxide layers in areas where water electrolysis may dominate. The statistical analysis may indicate no significant differences between Phase II-B and the preceding phases, suggesting that the transition to mixed electrochemical processes may not substantially alter the overall copper ion delivery.

Phase III-A may exhibit copper ion concentrations that may remain within the operational range observed during earlier phases, with values potentially measuring between approximately 420 and 520 micrograms per liter. The copper ion output during Phase III-A may be sustained primarily through the dissolution of remaining copper oxide layers under the acidic conditions created by water electrolysis reactions. The statistical analysis may continue to show no significant differences compared to earlier phases, indicating that the dissolution mechanism may effectively maintain antimicrobial metal delivery during the transition toward the self-cleaning phase.

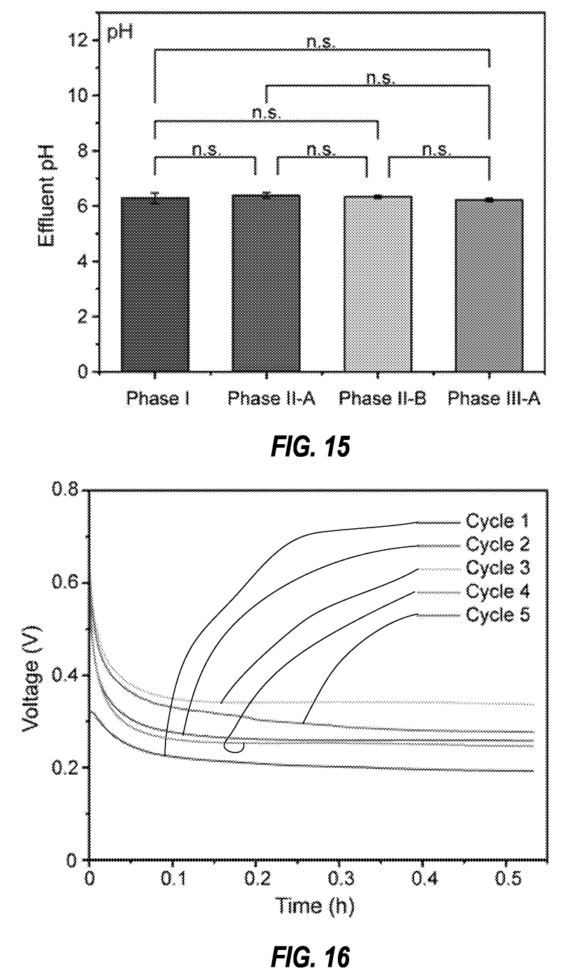

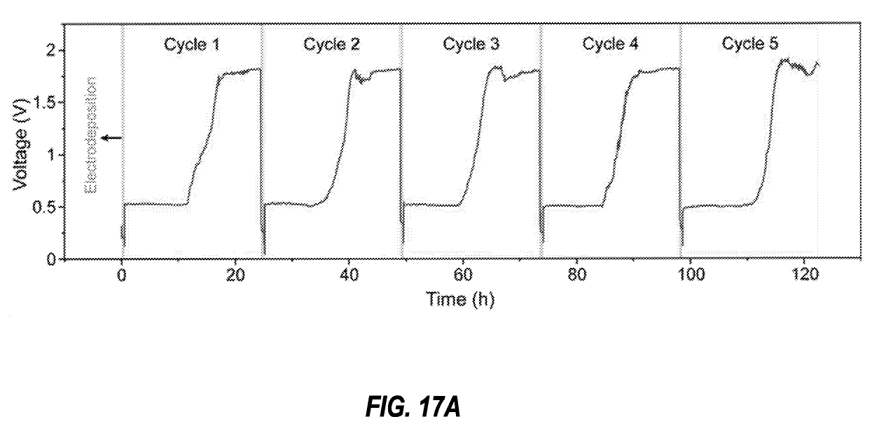

Referring to FIG. 15, the effluent pH measurements across the different operational phases may provide complementary information about the electrochemical processes occurring within the system. During Phase I, the effluent pH may remain stable at approximately 6.3, reflecting the balanced electrochemical reactions where copper ionization and copper oxide formation at the anode may be balanced by oxygen reduction reactions at the cathode that may consume hydrogen ions and may contribute to pH stability.

The pH measurements during Phase II-A may maintain similar values to Phase I, with effluent pH levels remaining at approximately 6.2 to 6.4. The pH stability during Phase II-A may indicate that the primary electrochemical processes may remain similar to Phase I, with copper ionization and oxide formation continuing to dominate despite the gradual voltage increase. The statistical analysis may show no significant differences between Phase I and Phase II-A pH values, supporting the conclusion that the fundamental electrochemical balance may be maintained during the early portion of the extended release phase.

During Phase II-B, the effluent pH may continue to remain stable at approximately 6.1 to 6.5, despite the onset of water electrolysis reactions that may produce hydrogen ions at the anode. The pH stability during Phase II-B may result from the consumption of the produced hydrogen ions through the acidic dissolution of copper oxide layers, creating a buffering effect that may maintain the overall pH balance. The statistical analysis may indicate no significant differences between Phase II-B and earlier phases, demonstrating that the system may maintain water chemistry stability even as the electrochemical mechanisms may become more complex.

Phase III-A may exhibit effluent pH values that may remain within the stable range observed during earlier phases, with measurements potentially ranging from approximately 6.0 to 6.6. The pH stability during Phase III-A may continue to be maintained through the consumption of hydrogen ions produced by water electrolysis through the ongoing dissolution of copper oxide layers. The statistical analysis may show no significant differences compared to preceding phases, indicating that the dissolution mechanism may effectively buffer the pH effects of increased water electrolysis activity.

The comparison between copper ion concentrations and pH measurements across the operational phases may reveal the coordinated nature of the electrochemical processes within the water disinfection system. The maintenance of stable copper ion delivery and pH values across Phase I, Phase II-A, Phase II-B, and Phase III-A may demonstrate the system's ability to adapt to changing electrode surface conditions while preserving the water quality characteristics necessary for effective disinfection performance.

The statistical analysis indicating no significant differences in both copper ion concentrations and pH values across the first four operational phases may support the conclusion that the system may provide consistent treatment performance throughout the majority of the operational cycle. This consistency may be important for automated control systems that may rely on predictable copper ion delivery and stable water chemistry for maintaining optimal disinfection conditions without requiring frequent parameter adjustments.

The coordinated stability of copper ion concentrations and pH values may also indicate that the transition between different electrochemical mechanisms may occur gradually rather than abruptly, allowing the system to maintain treatment effectiveness while the electrode surface may evolve from the initial copper shell configuration through various intermediate states toward the final self-cleaned stainless steel core condition.

The long-term operation of the water disinfection system may be evaluated through consecutive cycles of in situ electrode fabrication, regeneration, and ionization processes to demonstrate the repeatability and durability of the core-shell electrode configuration. A method of disinfecting water may comprise providing a water disinfection system comprising a cylindrical outer electrode, a center electrode positioned within the cylindrical outer electrode and comprising an inner wire and an outer shell, and a voltage source. The method may enable continuous operation without requiring system disassembly or electrode replacement through the alternating application of electrodeposition and ionization processes.

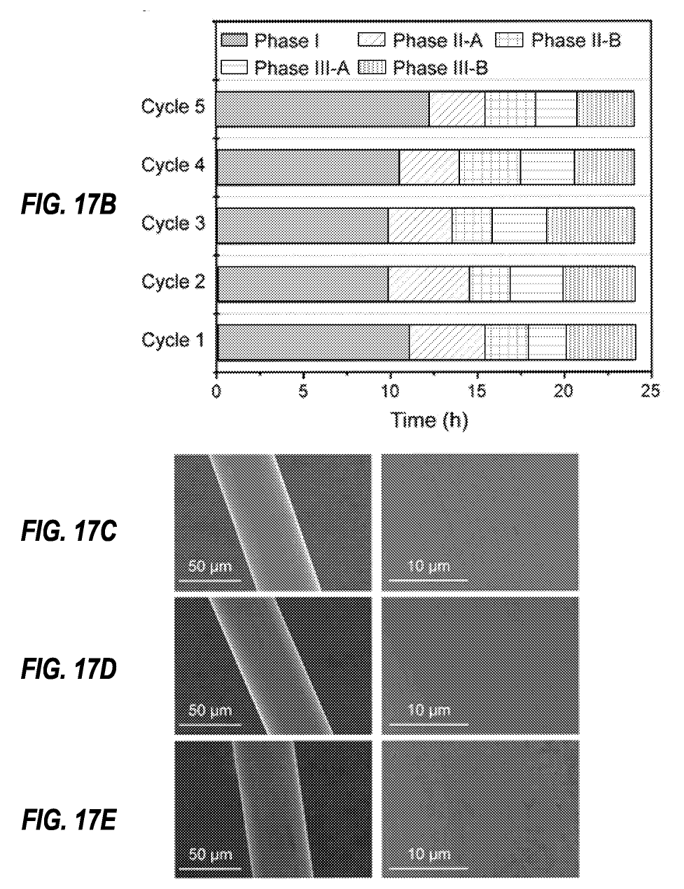

Referring to FIG. 17A, the voltage changes over time during five consecutive cycles of operation may demonstrate the consistent performance characteristics of the regenerative electrode system. Each operational cycle may exhibit similar voltage profiles, with initial stable voltage periods at approximately 0.5 volts followed by gradual increases to approximately 1.8 volts during the extended operational phases. These voltage values may be exemplary only, and the disclosure may not be limited to these specific values. Alternative initial voltage levels may range from 0.3 to 0.7 volts, or from 0.4 to 0.6 volts, while alternative maximum voltage levels may range from 1.5 to 2.1 volts, or from 1.6 to 2.0 volts, depending on the electrode surface conditions and operational parameters.

The method may involve applying a first voltage having a first polarity across the cylindrical outer electrode and the center electrode to electrodeposit metal from the cylindrical outer electrode onto the outer shell. The cylindrical outer electrode may comprise copper, and the inner wire may comprise stainless steel, providing the material combination that enables the regenerative electrode operation. The outer shell may comprise copper electrodeposited from the cylindrical outer electrode, forming the consumable layer that may provide antimicrobial metal ions during the subsequent ionization process.

The voltage profiles across all five cycles shown in FIG. 17A may exhibit remarkable consistency, with only minor fluctuations observed during the later portions of each cycle corresponding to the self-cleaning phases. The reproducible voltage patterns may indicate stable electrochemical processes and consistent electrode surface conditions following each regeneration cycle. The time duration for each complete cycle may extend for approximately 120 hours, including both the regeneration and ionization periods. This cycle duration may be exemplary only, and the disclosure may not be limited to this specific value. Alternative cycle durations may range from 100 to 140 hours, or from 110 to 130 hours, depending on the copper shell thickness and operational current density parameters.

The method may involve applying the first voltage comprising applying a current density of 30-50 milliamperes per square centimeter for approximately 20-40 minutes during the electrodeposition process. This current density range may be exemplary only, and the disclosure may not be limited to these specific values. Alternative current density ranges may include 25 to 60 milliamperes per square centimeter, or 35 to 45 milliamperes per square centimeter, depending on the desired deposition rate and surface quality requirements. The electrodeposition duration may be exemplary only, with alternative durations potentially ranging from 15 to 50 minutes, or from 25 to 35 minutes, depending on the target copper shell thickness and deposition efficiency.

Following the electrodeposition phase, the method may involve reversing polarity and applying a second voltage having a second polarity opposite the first polarity across the cylindrical outer electrode and the center electrode to ionize metal from the outer shell. The polarity reversal may transform the center electrode from a cathode during electrodeposition to an anode during ionization, enabling the release of copper ions from the deposited copper shell into the flowing water stream.

The method may involve applying the second voltage comprising applying a current of 0.1-1.0 milliamperes to produce copper ions at a concentration between 400 and 520 micrograms per liter in the water. This current range may be exemplary only, and the disclosure may not be limited to these specific values. Alternative current ranges may include 0.05 to 1.5 milliamperes, or 0.2 to 0.8 milliamperes, depending on the desired copper ion concentration and flow rate conditions. The copper ion concentration range may be exemplary only, with alternative concentration ranges potentially including 350 to 650 micrograms per liter, or 375 to 575 micrograms per liter, depending on the target microorganisms and water chemistry conditions.

The method may involve flowing water through the water disinfection system during application of the second voltage to disinfect the water with the ionized metal. The flowing water may transport the copper ions away from the electrode surface and may provide contact between the antimicrobial metal ions and microorganisms present in the water stream. The flow rate may be maintained at approximately 9.5 milliliters per minute, corresponding to a hydraulic retention time of approximately 1 minute. These flow parameters may be exemplary only, and the disclosure may not be limited to these specific values. Alternative flow rates may range from 5 to 15 milliliters per minute, or from 7 to 12 milliliters per minute, while alternative retention times may range from 0.5 to 2 minutes, or from 0.8 to 1.5 minutes.

Referring to FIGS. 17B, the duration of each operational phase may remain relatively stable across the five consecutive cycles, demonstrating the repeatability of the electrochemical processes and the consistency of the electrode regeneration mechanism. The controlled release phase (Phase I) may occupy the largest portion of each operational cycle, extending from the start of ionization to approximately 10-12 hours. This phase duration may be exemplary only, and the disclosure may not be limited to these specific values. Alternative durations for the controlled release phase may range from 8 to 15 hours, or from 9 to 13 hours, depending on the copper shell thickness and current density parameters.

The ionization process may operate through multiple phases comprising a controlled release phase, an extended release phase, and a self-cleaning phase that removes residual copper oxide from the inner wire. The extended release phase may be subdivided into Phase II-A and Phase II-B, with Phase II-A extending for approximately 2-4 hours and Phase II-B extending for approximately 2-3 hours. These phase durations may be exemplary only, and the disclosure may not be limited to these specific values. Alternative durations for Phase II-A may range from 1 to 6 hours, or from 2.5 to 3.5 hours, while alternative durations for Phase II-B may range from 1.5 to 4 hours, or from 2.2 to 2.8 hours.

The self-cleaning phase may be subdivided into Phase III-A and Phase III-B, with Phase III-A extending for approximately 2 hours and Phase III-B extending for approximately 5-6 hours. These self-cleaning phase durations may be exemplary only, and the disclosure may not be limited to these specific values. Alternative durations for Phase III-A may range from 1 to 4 hours, or from 1.5 to 2.5 hours, while alternative durations for Phase III-B may range from 3 to 8 hours, or from 4.5 to 6.5 hours, depending on the amount of residual copper oxide and the water electrolysis rate.

The long-term operational capability may result from the regenerative nature of the core-shell electrode configuration, which may eliminate the need for consumable electrode replacement that may limit the operational lifetime of conventional copper ionization systems. The stainless steel core may provide structural stability throughout multiple regeneration cycles, while the in situ copper electrodeposition process may restore the antimicrobial metal capacity without requiring system disassembly or maintenance interventions.

The repeatability demonstrated across five consecutive cycles may indicate that the system may be suitable for extended autonomous operation with minimal maintenance requirements. The consistent voltage profiles and phase durations may enable automated control systems to monitor and predict the operational status based on electrical parameters, facilitating the transition between electrodeposition and ionization phases without manual intervention. The predictable operational characteristics may support the development of automated control algorithms that may optimize the regeneration timing and operational parameters to maximize the copper utilization efficiency while maintaining consistent disinfection performance.

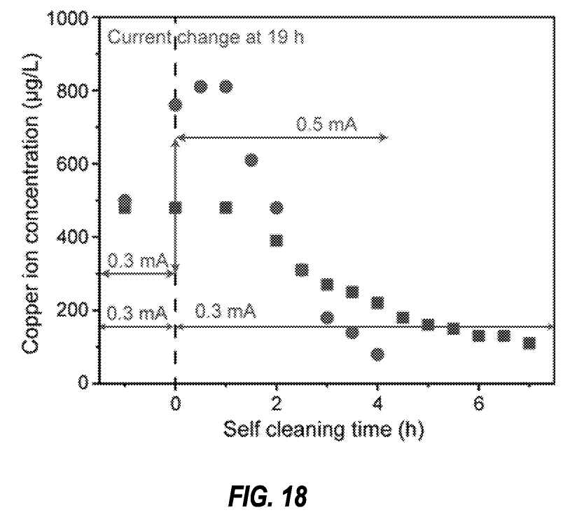

Referring to FIG. 18, the self-cleaning phase optimization may be achieved through strategic current adjustments that may reduce the duration of Phase III-B while maintaining copper ion concentrations within acceptable limits for water disinfection applications. The copper ion concentration changes during the self-cleaning phase may demonstrate the system's response to different current values applied after approximately 19 hours of operation at the standard current of 0.3 milliamperes. The optimization strategies may address concerns regarding the extended duration of Phase III-B and the declining copper ion concentrations that may result in reduced disinfection performance during the latter portion of the operational cycle.

The standard operational current of 0.3 milliamperes may result in Phase III-B extending for approximately 5 to 6 hours beyond the initial 20-hour operational period, during which copper ion concentrations may gradually decrease from approximately 450 micrograms per liter to levels approaching the influent baseline. This extended duration may be exemplary only, and the disclosure may not be limited to these specific values. Alternative Phase III-B durations under standard current conditions may range from 4 to 8 hours, or from 4.5 to 6.5 hours, depending on the amount of residual copper oxide and the rate of dissolution under the prevailing electrochemical conditions.

As shown in FIG. 18, increasing the operating current to 0.5 milliamperes during Phase III-B may substantially reduce the self-cleaning duration to approximately 3 hours while achieving a maximum copper ion concentration of approximately 760 micrograms per liter. This reduced duration may be exemplary only, and the disclosure may not be limited to this specific value. Alternative reduced durations for Phase III-B under increased current conditions may range from 2 to 5 hours, or from 2.5 to 3.5 hours, depending on the specific current level applied and the electrochemical response of the remaining copper oxide layers. The maximum copper ion concentration of 760 micrograms per liter may be exemplary only, with alternative maximum concentrations potentially ranging from 650 to 900 micrograms per liter, or from 700 to 820 micrograms per liter, while remaining within regulatory limits for drinking water applications.

The increased current density during Phase III-B may accelerate both the water electrolysis reactions that produce hydrogen ions and the subsequent acidic dissolution of copper oxide layers that release copper ions into the water stream. The enhanced electrochemical activity may result in more rapid consumption of the remaining copper oxide deposits, thereby shortening the time required to achieve complete electrode cleaning while potentially providing higher copper ion concentrations for enhanced antimicrobial activity during the final operational phase.

The system may implement stepwise current increases during the self-cleaning phase as an alternative optimization strategy that may provide more controlled copper ion release profiles while reducing the overall Phase III-B duration. A stepwise current increase protocol may involve incrementing the current by approximately 0.1 milliamperes per hour during Phase III-B, beginning from the standard operational current of 0.3 milliamperes. This incremental approach may be exemplary only, and the disclosure may not be limited to these specific values. Alternative stepwise increment values may range from 0.05 to 0.2 milliamperes per hour, or from 0.08 to 0.15 milliamperes per hour, depending on the desired rate of copper oxide dissolution and the target copper ion concentration profile.

The stepwise current increase strategy may enable fine-tuning of the copper ion release rate during the self-cleaning phase, potentially maintaining copper ion concentrations within a narrower range compared to abrupt current increases. The gradual current increases may allow the system to respond to the changing electrode surface conditions as copper oxide layers may be progressively dissolved, avoiding excessive copper ion concentrations that might exceed regulatory limits while ensuring adequate antimicrobial activity throughout the self-cleaning period.

The stepwise approach may commence with an initial current increase from 0.3 to 0.4 milliamperes during the first hour of Phase III-B, followed by subsequent increases to 0.5 milliamperes during the second hour and potentially to 0.6 milliamperes during the third hour if additional copper oxide dissolution may be required. These specific current values and timing intervals may be exemplary only, and the disclosure may not be limited to these parameters. Alternative stepwise current progressions may include increases from 0.3 to 0.45 milliamperes in the first hour, 0.45 to 0.6 milliamperes in the second hour, and 0.6 to 0.75 milliamperes in subsequent hours, or other progression patterns ranging from 0.25 to 0.8 milliamperes total current range with increments of 0.05 to 0.25 milliamperes per time interval.

An alternative optimization approach may involve terminating the ionization process at approximately 20 hours by introducing electrolyte directly into the system to eliminate Phase III-B altogether. This termination strategy may take advantage of the highly acidic nature of the electrolyte solution used for copper electrodeposition, which may rapidly dissolve any remaining copper oxide layers on the electrode surface. The direct introduction of electrolyte at 20 hours may be exemplary only, and the disclosure may not be limited to this specific timing. Alternative termination times may range from 18 to 22 hours, or from 19 to 21 hours, depending on the operational requirements and the extent of copper oxide formation during the preceding phases.

The electrolyte solution comprising copper sulfate and sulfuric acid may provide the acidic conditions necessary for rapid copper oxide dissolution, effectively achieving the same electrode cleaning result as the extended Phase III-B period but in a significantly shorter time frame. The acidic dissolution may occur according to the reaction Cu₂O + O₂ + 4H⁺ → 2Cu²⁺ + 2H₂O, where the hydrogen ions provided by the electrolyte may facilitate the conversion of copper oxide back to soluble copper ions that may be recovered in the electrolyte solution for potential reuse in subsequent electrodeposition cycles.

The direct electrolyte introduction approach may reduce the operational time from approximately 25-26 hours to approximately 20 hours while achieving a copper utilization efficiency of approximately 86.6%. This reduced operational time may be exemplary only, and the disclosure may not be limited to this specific value. Alternative reduced operational times may range from 18 to 22 hours, or from 19 to 21 hours, depending on the specific termination timing and electrode conditions. The copper utilization efficiency of 86.6% may be exemplary only, with alternative efficiency values potentially ranging from 80% to 95%, or from 83% to 90%, while remaining significantly higher than conventional pure copper wire systems.

The copper recovered in the electrolyte solution through the direct termination approach may be recycled for use in subsequent electrodeposition cycles, potentially improving the overall material utilization efficiency of the system. The recycling of dissolved copper may reduce the consumption of fresh copper from the outer electrode during regeneration cycles, extending the operational lifetime of the outer electrode and reducing the material costs associated with long-term system operation.

The optimization strategies for Phase III-B may be selected based on specific application requirements, including the desired operational duration, copper ion concentration profiles, and maintenance scheduling constraints. Applications requiring maximum operational time per cycle may benefit from the current increase strategies that may reduce Phase III-B duration while maintaining copper ion delivery. Applications with flexible scheduling may utilize the direct electrolyte introduction approach to minimize the total cycle time and maximize the copper utilization efficiency through electrolyte recycling.

The implementation of Phase III-B optimization strategies may be integrated into automated control systems that may monitor operational parameters such as voltage, current, and copper ion concentration to determine the optimal timing and method for transitioning between operational phases. The control systems may utilize predictive algorithms based on the operational history and electrode performance characteristics to select the most appropriate optimization approach for each operational cycle, maximizing the system efficiency while maintaining consistent water disinfection performance.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A system for disinfecting a fluid, comprising:
a cylindrically-shaped outer electrode defining an internal cavity;
a center electrode positioned within the internal cavity, the center electrode extending along at least a portion of a longitudinal axis of the outer electrode, the center electrode comprising an inner wire and an outer shell surrounding the inner wire;
an inlet positioned proximate a first end of the outer electrode and configured to allow a fluid to pass from an area external to the cavity into the cavity;
an outlet positioned proximate a second end of the outer electrode and configured to allow the fluid to pass from the cavity into an area external to the cavity; and
a voltage source configured to apply a voltage across the outer electrode and the center electrode.

2. The system of claim 1, wherein the outer electrode comprises copper, silver, or zinc.

3. The system of claim 1, wherein the inner wire comprises stainless steel.

4. The system of claim 3, wherein the outer shell comprises copper.

5. The system of claim 1, wherein application of a first voltage having a first polarity results in electrodeposition of a metal from the outer electrode to the outer shell.

6. The system of claim 5, wherein application of a second voltage having a second polarity opposite the first polarity results in ionization of the metal of the outer shell.

7. The system of claim 6, wherein the metal comprises copper and the ionization produces copper ions at a concentration between 400 and 520 micrograms per liter in the fluid.

8. A water disinfection device, comprising:
a tubular outer electrode comprising copper, silver, or zinc and defining an internal flow channel;
a core-shell center electrode positioned within the internal flow channel and extending along a longitudinal axis of the tubular outer electrode, the core-shell center electrode comprising a wire core and a shell electrodeposited onto the wire core;
a fluid inlet configured to introduce water into the internal flow channel;
a fluid outlet configured to discharge treated water from the internal flow channel; and
an electrical circuit configured to selectively apply a first voltage having a first polarity to cause electrodeposition of copper from the tubular outer electrode onto the wire core and a second voltage having a second polarity opposite the first polarity to cause ionization of metal from the shell.

9. The water disinfection device of claim 8, wherein the wire of the core-shell center electrode comprises stainless steel and the shell of the core-shell center electrode comprises copper.

10. The water disinfection device of claim 9, wherein the copper shell has a thickness between 15 and 20 micrometers when electrodeposited onto the stainless steel wire core.

11. The water disinfection device of claim 8, wherein the electrical circuit is configured to apply the first voltage at a current density of 30-50 milliamperes per square centimeter during electrodeposition.

12. The water disinfection device of claim 11, wherein the electrodeposition is performed for a duration of approximately 20-40 minutes to achieve a desired copper shell thickness.

13. The water disinfection device of claim 8, wherein the electrical circuit is configured to apply the second voltage at a current of 0.1-1.0 milliamperes during copper ionization to produce copper ions at a concentration between 400 and 520 micrograms per liter.

14. The water disinfection device of claim 13, wherein the copper ionization operates in multiple phases comprising a controlled release phase, an extended release phase, and a self-cleaning phase.

15. A method of disinfecting water, comprising:
providing a water disinfection system comprising a cylindrical outer electrode, a center electrode positioned within the cylindrical outer electrode and comprising an inner wire and an outer shell, and a voltage source;
applying a first voltage having a first polarity across the cylindrical outer electrode and the center electrode to electrodeposit metal from the cylindrical outer electrode onto the outer shell;
reversing polarity and applying a second voltage having a second polarity opposite the first polarity across the cylindrical outer electrode and the center electrode to ionize metal from the outer shell; and
flowing water through the water disinfection system during application of the second voltage to disinfect the water with the ionized metal.

16. The method of claim 15, wherein the cylindrical outer electrode comprises copper, silver, or zinc and the inner wire comprises stainless steel.

17. The method of claim 16, wherein the outer shell comprises copper electrodeposited from the cylindrical outer electrode.

18. The method of claim 15, wherein applying the first voltage comprises applying a current density of 30-50 milliamperes per square centimeter for approximately 20-40 minutes.

19. The method of claim 18, wherein applying the second voltage comprises applying a current of 0.1-1.0 milliamperes to produce copper ions at a concentration between 400 and 520 micrograms per liter in the water.

20. The method of claim 19, wherein the ionization operates through multiple phases comprising a controlled release phase, an extended release phase, and a self-cleaning phase that removes residual copper oxide from the inner wire.
